(19) United States
(12) Patent Application Publication
(10) Pub. No.: US 2007/0290421 A1
(43) Pub. Date: Dec. 20, 2007

(54) Pneumatic cylinder device

(75) Inventor: Yu-Jen Wang, Tainan Hsien (TW)

Correspondence Address: OSTROLENK, FABER, GERB & SOFFEN, LLP, 1180 Avenue of the Americas, New York, NY, 10036-8403, US

(73) Assignee: FU LUONG HI-TECH Co., Ltd

(21) Appl. No.: 11/471,041

(22) Filed: Jun. 19, 2006

(51) Int. Cl. F16F 9/342

(52) U.S. Cl. 267/64.22; 267/64.11

(57) ABSTRACT

A pneumatic cylinder device includes an outer cylinder, an inner cylinder unit, a piston unit, and a control valve. The inner cylinder unit includes an inner cylinder, and a flow passage formation plate disposed between the inner and outer cylinders. The flow passage formation plate cooperates with a groove bottom wall to define a flow passage communicated with first and second air-guiding holes in the groove bottom wall. The first and second air-guiding holes are communicated respectively with first and second chamber parts of an air chamber in the inner cylinder. The control valve is disposed between the first air-guiding hole and the first chamber part.

### BACKGROUND OF THE INVENTION

1. Field of the Invention

The invention relates to a pneumatic device, more particularly to a pneumatic cylinder device.

2. Description of the Related Art

FIGS. 1 and 2 illustrate a conventional pneumatic cylinder device 1 that includes a metallic outer cylinder 11, an inner cylinder 12 disposed in the outer cylinder 11, an L-shaped air conduit 10, a piston unit 13, and a control valve unit 14.

The inner cylinder 12 is made of a rigid plastic material, and has a cylinder body 120 that defines an air chamber 121, an actuator-mounting space 123 opposite to the air chamber 121 in an axial direction, and a valve-mounting space 122 disposed between the air chamber 121 and the actuator-mounting space 123.

The piston unit 13 includes a piston 131 disposed movably and sealingly in the air chamber 121 in the inner cylinder 12 and movable relative to the inner cylinder 12 in the axial direction such that the air chamber 121 is divided into volume-changeable first and second chamber parts 1211, 1212, and a piston rod 132 connected fixedly to the piston 131 and extending outwardly of the second chamber part 1212 of the air chamber 121. The air conduit 10 is embedded in the cylinder body 120 of the inner cylinder 12, and has opposite first and second open ends that are respectively communicated with the valve-mounting space 122 and the second chamber part 1212 of the air chamber 121.

The control valve unit 14 includes a control valve 141 disposed movably and sealingly in the valve-mounting space 122 in the inner cylinder 12, and an actuator 142 connected to the control valve 141 and disposed in the actuator-mounting space 123. The actuator 142 is operable so as to enable the control valve 141 to move between a closed position, where the first chamber part 1211 of the air chamber 121 is not in spatial communication with the valve-mounting space 122, as shown in FIG. 1, and an opened position, where the first chamber part 1211 of the air chamber 121 is in spatial communication with the valve-mounting space 122 such that the first and second chamber parts 1211, 1212 of the air chamber 121 are in spatial communication with each other via the air conduit 10, as shown in FIG. 2.

However, in actual fabrication, it is hard to embed fixedly the air conduit 10 in the cylinder body 120 of the inner cylinder 12. Furthermore, when the conventional pneumatic cylinder device 1 is reduced in size, it is difficult to form the air conduit 10 with a reduced size matching the shrunk conventional pneumatic cylinder device 1.

### SUMMARY OF THE INVENTION

Therefore, the object of the present invention is to provide a pneumatic cylinder device that can eliminate the aforesaid drawbacks of the prior art.

According to the present invention, a pneumatic cylinder device comprises:

an outer cylinder;

an inner cylinder unit disposed in the outer cylinder and including

an inner cylinder made of a plastic material and having a cylinder body that defines an air chamber and a valve-mounting space therein, the cylinder body having an annular outer surface abutting against the outer cylinder and formed with a plate-mounting groove that extends in an axial direction and that is defined by a groove bottom wall and an annular surrounding wall, the groove bottom wall being formed with first and second air-guiding holes that are spaced apart from each other in the axial direction and that are communicated respectively with the valve-mounting space and the air chamber, and

a flow passage formation plate made of a plastic material, disposed between the outer cylinder and the inner cylinder, mounted fixedly in the plate-mounting groove, and cooperating with the groove bottom wall of the cylinder body of the inner cylinder to define a flow passage therebetween, the flow passage being in spatial communication with the first and second air-guiding holes in the groove bottom wall of the cylinder body of the inner cylinder;

a piston unit disposed movably and sealingly in the air chamber in the inner cylinder and movable relative to the inner cylinder in the axial direction such that the air chamber is divided into volume-changeable first and second chamber parts, the first chamber part of the air chamber being in spatial communication with the valve-mounting space in the inner cylinder, the second chamber part of the air chamber being in spatial communication with the second air-guiding hole in the groove bottom wall of the cylinder body of the inner cylinder; and

a control valve disposed sealingly in the valve-mounting space in the inner cylinder and movable between a closed position, where the first chamber part of the air chamber is not in spatial communication with the valve-mounting space, and an opened position, where the first chamber part of the air chamber is in spatial communication with the valve-mounting space such that the first and second chamber parts of the air chamber are in spatial communication with each other via the first and second air-guiding holes in the groove bottom wall of the cylinder body of the inner cylinder and the flow passage.

### BRIEF DESCRIPTION OF THE DRAWINGS

Other features and advantages of the present invention will become apparent in the following detailed description of the preferred embodiment with reference to the accompanying drawings, of which:.

FIG. 1 is a fragmentary schematic sectional view showing a conventional pneumatic cylinder device when a control valve thereof is in a closed position;

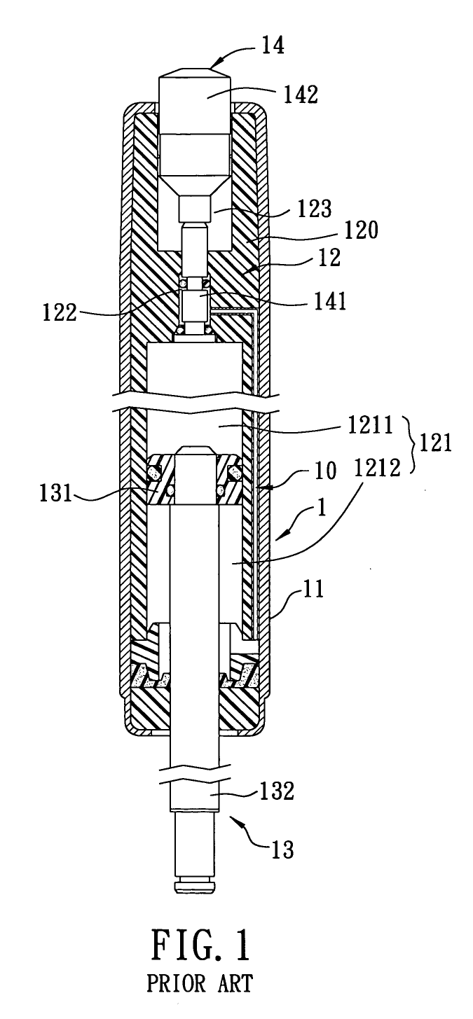

FIG. 2 is a fragmentary schematic sectional view showing the conventional pneumatic cylinder device when the control valve is in an opened position;

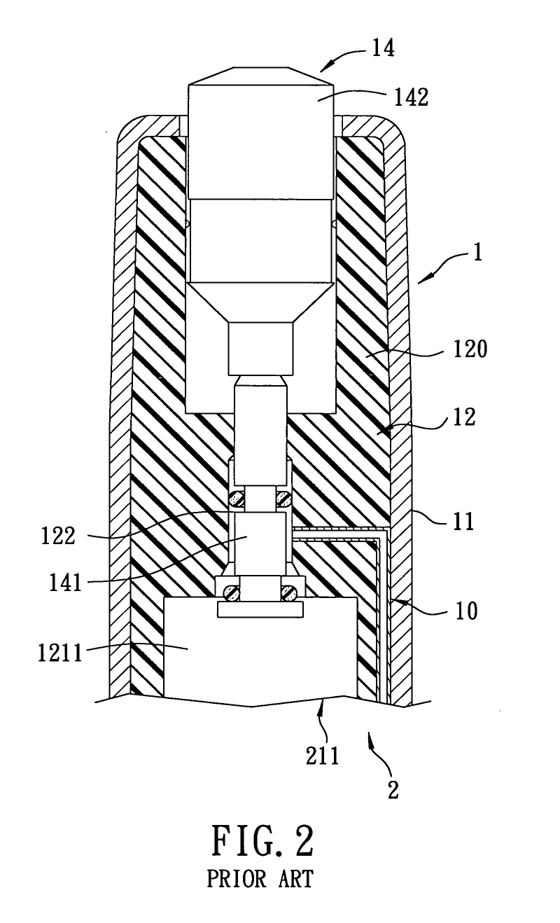

FIG. 3 is a fragmentary schematic sectional view showing the preferred embodiment of a pneumatic cylinder device according to the present invention when a control valve is in a closed position;

FIG. 4 is an exploded fragmentary perspective view showing an inner cylinder unit of the preferred embodiment;

FIG. 5 is a schematic sectional view taken along line V-V of FIG. 3 and only showing the inner cylinder unit; and

FIG. 6 is a fragmentary schematic sectional view showing the preferred embodiment when the control valve is in an opened position.

### DETAILED DESCRIPTION OF THE PREFERRED EMBODIMENT

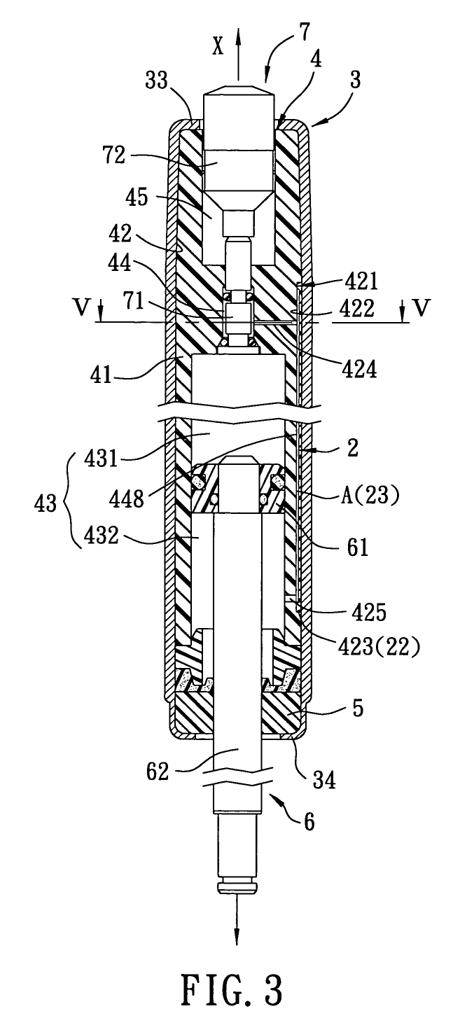

Referring to FIG. 3, the preferred embodiment of a pneumatic cylinder device according to the present invention is shown to include a tubular outer cylinder 3, an inner cylinder unit, a piston unit 6, and a control valve unit 7.

The outer cylinder 3 is made of metal, and has first and second open ends 33, 34 opposite to each other in an axial direction (X).

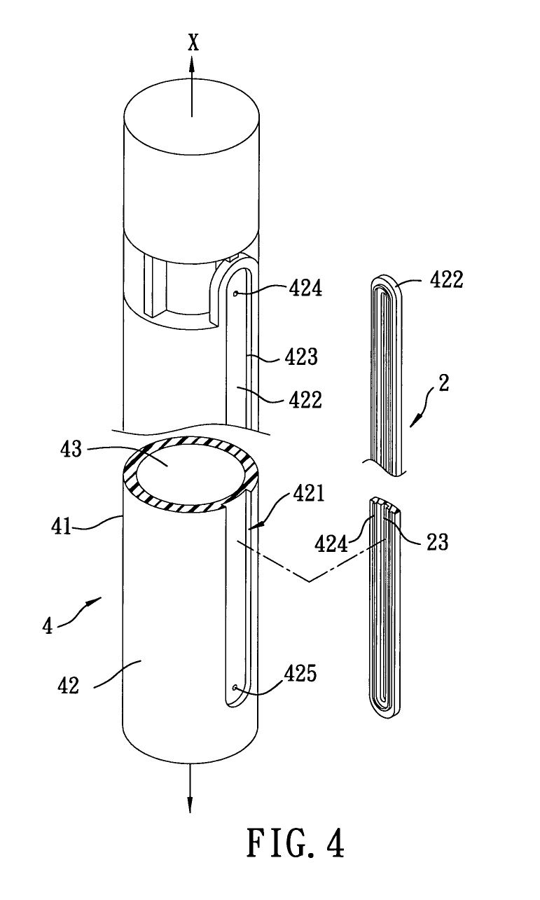

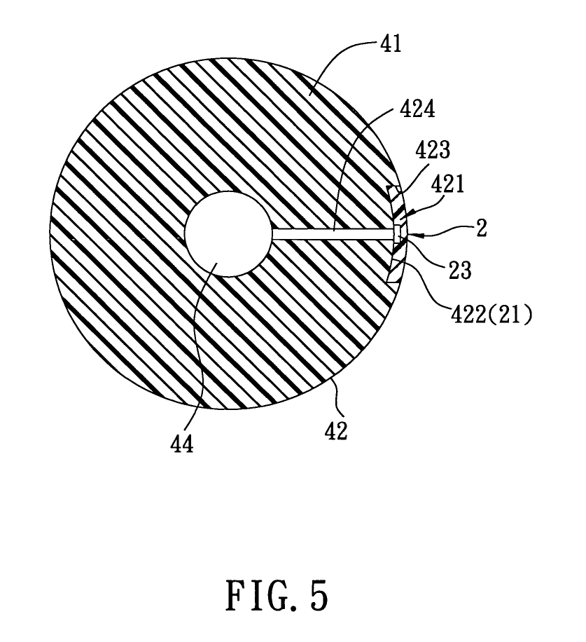

Referring further to FIGS. 4 and 5, the inner cylinder unit is disposed in the outer cylinder 3, and includes an inner cylinder 4 and a flow passage formation plate 2.

The inner cylinder 4 is unitary, and is made of a rigid plastic material. The inner cylinder 4 has a tubular cylinder body 41 that defines an actuator-mounting space 45, an air chamber 43 opposite to the actuator-mounting space 45, and a valve-mounting space 44 disposed between the actuator-mounting space 45 and the air chamber 43. In this embodiment, the actuator-mounting space 45 and the air chamber 43 are respectively disposed adjacent to the first and second open ends 33, 34 of the outer cylinder 3, as shown in FIG. 3. The valve-mounting space 44 has a diameter smaller than those of the actuator-mounting space 45 and the air chamber 43. The cylinder body 41 has an annular outer surface 42 abutting against the outer cylinder 3 and formed with a plate-mounting groove 421 that extends in the axial direction (X) and that is defined by a groove bottom wall 422 and an annular surrounding wall 423. The groove bottom wall 422 of the cylinder body 41 is formed with first and second air-guiding holes 424, 425 that are spaced apart from each other in the axial direction (X) and that are communicated respectively with the valve-mounting space 44 and the air chamber 43. In this embodiment, the groove bottom wall 422 of the cylinder body 41 is curved (see FIG. 5).

Referring further to FIG. 5, the flow passage formation plate 2 is made of a rigid plastic material, is disposed between the outer cylinder 3 and the inner cylinder 4, and is mounted fixedly in the plate-mounting groove 421 by heat pressing, such as high frequency heating. In this embodiment, the flow passage formation plate 2 has a curved mounting surface 21 abutting against the groove bottom wall 422 of the cylinder body 41 of the inner cylinder 4 and formed with an axially extending groove 23 (see FIG. 4) such that the flow passage formation plate 2 cooperates with the groove bottom wall 422 of the cylinder body 41 of the inner cylinder 4 to define a flow passage (A) therebetween, as shown in FIG. 3. The flow passage (A) is in spatial communication with the first and second air-guiding holes 424, 425 in the groove bottom wall 422 of the cylinder body 41 of the inner cylinder 4. It is noted that, prior to attachment of the flow passage formation plate 2 to the inner cylinder 4, the flow passage formation plate 2 is formed integrally with an annular protrusion 24, as shown in FIG. 4. When undergoing heat pressing, the annular protrusion 24 melts. Hence, the curved mounting surface 21 is formed as described above. The flow passage formation plate 2 further has an annular outer surface 22 abutting against the annular surrounding wall 423 of the cylinder body 41 of the inner cylinder 4 so that the flow passage formation plate 2 engages fittingly the plate-mounting groove 421 in the cylinder body 41 of the inner cylinder 4.

The piston unit 6 is disposed movably and sealingly in the air chamber 43 in the inner cylinder 4, and is movable relative to the inner cylinder 4 in the axial direction (X) such that the air chamber 43 is divided into volume-changeable first and second chamber parts 431, 432. The first chamber part 431 of the air chamber 43 is in spatial communication with the valve-mounting space 44 in the inner cylinder 4. The second chamber part 432 of the air chamber 43 is in spatial communication with the second air-guiding hole 425 in the groove bottom wall 422 of the cylinder body 41 of the inner cylinder 4, as shown in FIG. 3. In this embodiment, the piston unit 6 includes a piston 61 disposed movably and sealingly in the air chamber 43 and disposed between the first and second chamber parts 431, 432, and a piston rod 62 connected fixedly to the piston 61 and extending outwardly of the second chamber part 432 of the air chamber 43 through a seal cap 5 that is mounted sealingly between the second open end 34 of the outer cylinder 3 and the inner cylinder 3.

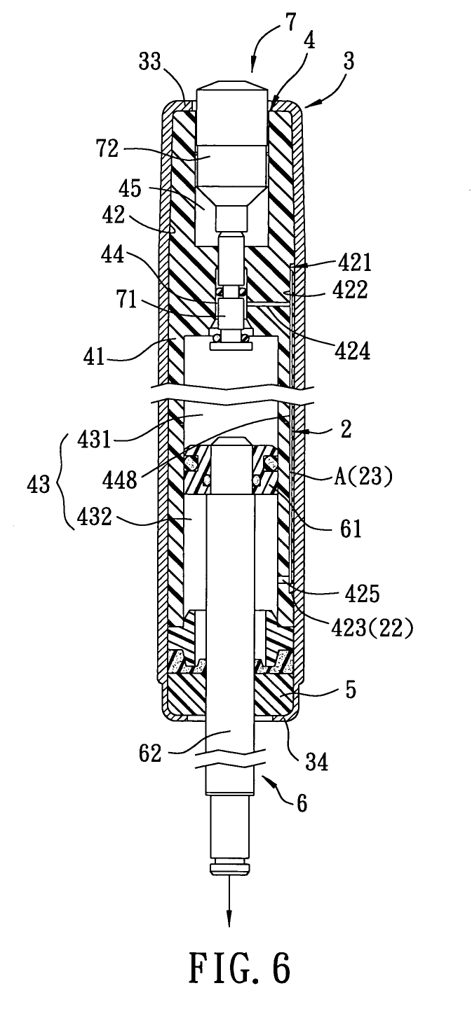

In this embodiment, the control valve unit 7 includes a control valve 71 and an actuator 72. The control valve 71 is disposed movably and sealingly in the valve-mounting space 44. The actuator 72 is connected fixedly to the control valve 71, is disposed movably in the actuator-mounting space 45, and extends outwardly of the outer cylinder 3 via the first open end 33. The actuator 72 is operable so as to enable the control valve 71 to move between a closed position, wherein the first chamber part 431 of the air chamber 43 is not in spatial communication with the valve-mounting space 44, as shown in FIG. 3, and an opened position, where the first chamber part 431 of the air chamber 43 is in spatial communication with the valve-mounting space 44 such that the first and second chamber parts 431, 432 of the air chamber 43 are in spatial communication with each other via the first and second air-guiding holes 424, 425 in the groove bottom wall 422 of the cylinder body 41 of the inner cylinder 4 and the flow passage (A), as shown in FIG. 6.

In the present invention, the flow passage (A) can be easily formed by mounting the flow passage formation plate 2 in the plate-mounting groove 421 in the cylinder body 41 of the inner cylinder 4 through heat pressing even if the pneumatic cylinder device has a small size.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A pneumatic cylinder device comprising:
an outer cylinder;
an inner cylinder unit disposed in said outer cylinder and including
an inner cylinder made of a plastic material and having a cylinder body that defines an air chamber and a valve-mounting space therein, said cylinder body having an annular outer surface abutting against said outer cylinder and formed with a plate-mounting groove that extends in an axial direction and that is defined by a groove bottom wall and an annular surrounding wall, said groove bottom wall being formed with first and second air-guiding holes that are spaced apart from each other in the axial direction and that are communicated respectively with said valve-mounting space and said air chamber, and
a flow passage formation plate made of a plastic material, disposed between said outer cylinder and said inner cylinder, mounted fixedly in said plate-mounting groove, and cooperating with said groove bottom wall of said cylinder body of said inner cylinder to define a flow passage therebetween, said flow passage being in spatial communication with said first and second air-guiding holes in said groove bottom wall of said cylinder body of said inner cylinder;
a piston unit disposed movably and sealingly in said air chamber in said inner cylinder and movable relative to said inner cylinder in the axial direction such that said air chamber is divided into volume-changeable first and second chamber parts, said first chamber part of said air chamber being in spatial communication with said valve-mounting space in said inner cylinder, said second chamber part of said air chamber being in spatial communication with said second air-guiding hole in said groove bottom wall of said cylinder body of said inner cylinder; and
a control valve disposed sealingly in said valve-mounting space in said inner cylinder and movable between a closed position, where said first chamber part of said air chamber is not in spatial communication with said valve-mounting space, and an opened position, where said first chamber part of said air chamber is in spatial communication with said valve-mounting space such that said first and second chamber parts of said air chamber are in spatial communication with each other via said first and second air-guiding holes in said groove bottom wall of said cylinder body of said inner cylinder and said flow passage.

2. The pneumatic cylinder device as claimed in claim 1, wherein said groove bottom wall of said cylinder body of said inner cylinder is curved, and said flow passage formation plate has a curved mounting surface abutting against said groove bottom wall of said cylinder body of said inner cylinder and formed with an axially extending groove that serves as said flow passage.

3. The pneumatic cylinder device as claimed in claim 2, wherein said flow passage formation plate further has an annular outer surface abutting against said annular surrounding wall of said cylinder body of said inner cylinder so that said flow passage formation plate engages fittingly said plate-mounting groove in said cylinder body of said inner cylinder.

4. The pneumatic cylinder device as claimed in claim 1, wherein said piston unit includes a piston disposed movably and sealingly in said air chamber and disposed between said first and second chamber parts, and a piston rod connected fixedly to said piston and extending outwardly of said second chamber part of said air chamber.
